(19) United States
(12) Patent Application Publication
(10) Pub. No.: US 2025/0065448 A1
(43) Pub. Date: Feb. 27, 2025

(54) Electrode Lead Aligning and Masking Device

(71) Applicant: LG Energy Solution, Ltd., Seoul (KR)

(72) Inventor: Tae Wook Kim, Daejeon (KR)

(73) Assignee: LG Energy Solution, Ltd., Seoul (KR)

(21) Appl. No.: 18/728,631

(22) PCT Filed: Feb. 20, 2023
(86) PCT No.: PCT/KR2023/002396

§ 371 Date: Jul. 12, 2024

(30) Foreign Application Priority Data
Feb. 22, 2022 (KR) 10-2022-0022936

(51) Int. Cl. B23K 35/02; H01M 50/516

(52) U.S. Cl. CPC B23K 35/02; H01M 50/516

(57) ABSTRACT

Disclosed herein is an electrode lead aligning and masking device. The electrode lead aligning and masking device of the present disclosure can be configured to align electrode leads bent on each of bus bars in a welding process of the electrode leads. The electrode lead aligning and masking device can include a pair of aligning jigs, each inserted into a slot between the bus bars and configured to align positions of the electrode leads. A masking jig can be disposed between the pair of aligning jigs to surround welding portions of the electrode leads.

### CROSS-REFERENCE TO RELATED APPLICATIONS

This application is a national phase entry under 35 U.S.C. § 371 of International Application No. PCT/KR2023/002396 filed on Feb. 20, 2023, which claims the benefit of priority to Korean Patent Application No. 10-2022-0022936, filed Feb. 22, 2022, in the Korean Intellectual Property Office, the disclosures of which are incorporated herein by reference in their entirety.

### TECHNICAL FIELD

The present invention relates to an electrode lead aligning and masking device, and more particularly, to an electrode lead aligning and masking device capable of aligning an electrode lead bent on a bus bar at a correct position, significantly reducing a welding defect rate, and preventing damage to an electrode rib.

### BACKGROUND ART

In general, a secondary battery includes a positive electrode, a negative electrode, and an electrolyte, and generate electric energy by using a chemical reaction. The use of secondary batteries is gradually increasing due to the advantage of being able to charge and discharge. Among these secondary batteries, lithium secondary batteries have a high energy density per unit weight, and thus are widely used as power sources for electronic communication devices, driving sources for high-power hybrid vehicles and electric vehicles, or the like.

In terms of the shape of the secondary batteries, there is a growing demand for prismatic-type secondary batteries and pouch-type secondary batteries that can be applied to products such as mobile phones and the like due to their small thickness. In terms of the material of the secondary batteries, there is a growing demand for lithium secondary batteries, such as lithium-ion batteries and lithium-ion polymer batteries, which have high energy density, discharge voltage, and output stability.

A plurality of battery cells are stacked inside a battery case of the secondary battery. Electrode tabs are formed to protrude from each of the plurality of battery cells, and an electrode lead is welded to each of the electrode tabs. A negative electrode lead and a positive electrode lead are bent to overlap a bus bar by a bending tool in a bending process. In a welding process, which is a subsequent process of the bending process, the bent negative and positive electrode leads are welded to the bus bar by a welding tool in an overlapped state.

However, conventionally, when the welding process is performed after the electrode lead bending process, the bent electrode leads are welded to the bus bar in an unaligned state. Accordingly, even when a plurality of electrode leads are unified in length, a welding length of the electrode lead varies, and thus a welding defect rate may be increased.

In addition, when a pair of electrode leads are bent in a state in which the pair of electrode leads are spread outward in a width direction of the bus bar, the length at which the pair of electrode leads are overlapped is reduced. In this case, when the overlapping portion is welded while being pressed with a masking jig, an actual welding section becomes shorter than a design welding section, and thus, a bonding strength of the welding portion is significantly reduced.

In addition, when a pair of electrode leads are bent in a state in which the pair of electrode leads are gathered toward both side surfaces in the width direction of the bus bar, the length at which the pair of electrode leads are overlapped is excessively increased. In this case, end portions of the pair of electrode leads overlap a portion bent to be rounded, and thus the overlapping portion of the pair of electrode leads may be locally lifted or a gap may widen. Accordingly, the bonding strength of the welding portion may be reduced. In addition, welding sparks or spatters may splash in the vicinity, and thus a welding defect rate may be increased.

In addition, since the welding length of the pair of electrode leads in each bus bar may be different, an actual welding length deviates from the required design dimension, and thus a welding defect rate may be increased.

The background art of the present invention is disclosed in Korean Patent Publication No. 2019-0097614 (published on Aug. 21, 2019, title of the invention: Jig for spot welding).

### DISCLOSURE

### Technical Solution

The present invention has been made to solve the above problems, and is directed to providing an electrode lead aligning and masking device capable of aligning an electrode lead bent on a bus bar at a correct position and significantly reducing a welding defect rate.

The present invention is also directed to providing an electrode lead aligning and masking device allowing an actual welding length of an electrode lead to be matched with a design welding length thereof.

The present invention is also directed to providing an electrode lead aligning and masking device capable of preventing electrode leads from spreading outward in a width direction of a bus bar and thus preventing a bonding area and a bonding strength of a welding portion from being reduced.

The present invention is also directed to providing an electrode lead aligning and masking device capable of preventing an overlapping portion of a pair of electrode leads from being locally lifted or preventing a gap from widening.

The present invention is also directed to providing an electrode lead aligning and masking device capable of preventing an electrode lead and an aligning jig from being damaged.

### Technical Solution

One aspect of the present invention provides an electrode lead aligning and masking device configured to align electrode leads bent on each of bus bars in a welding process of the electrode leads, the electrode lead aligning and masking device including a pair of aligning jigs each inserted into a slot between the bus bars and configured to align positions of the electrode leads, and a masking jig disposed between the pair of aligning jigs and surrounding welding portions of the electrode leads.

The pair of aligning jigs may be coupled to both sides of the masking jig in a width direction.

The aligning jig may gather the electrode lead toward the bus bar while being inserted into the slot on an outer side of the electrode lead.

The aligning jig may include an alignment body portion facing each of both sides of the masking jig, and an alignment rib extending from the alignment body portion, formed to be thinner than a thickness of the alignment body portion, and configured to align the electrode lead while being inserted into the slot.

An alignment taper portion may be formed on an inner side of the alignment rib in a thickness direction to gather the electrode lead toward the bus bar.

A stepped portion may be formed on a lower side of the alignment body portion to be spaced apart from a bent portion of the electrode lead, and a pressing surface portion of the masking jig may be disposed at a lower position than the stepped portion.

The aligning jig may be formed in a shape of a rectangular panel.

A welding space portion passing through the masking jig in a vertical direction may be formed in the masking jig.

The masking jig may be formed in a shape of a rectangular cylinder parallel to the bus bar in a longitudinal direction, and the welding space portion may be formed parallel to the bus bar in the longitudinal direction.

The masking jig may press the electrode lead to the bus bar.

Another aspect of the present invention provides an electrode lead aligning and masking device configured to align electrode leads bent on each of bus bars in a welding process of the electrode leads, the electrode lead aligning and masking device including a pair of aligning jigs each inserted into a slot between the bus bars and configured to align positions of the electrode leads, a masking jig which is disposed between the pair of aligning jigs and installed to surround welding portions of the electrode leads, and to which the aligning jigs are movably coupled, and at least two elastic members respectively installed on both sides of the masking jig to elastically support the pair of aligning jigs.

The masking jig may include a masking body portion having a welding space portion passing therethrough in a vertical direction, and a sliding guide portion disposed on each of both sides of the masking body portion and formed with a sliding groove portion to which the aligning jig is slidably coupled.

The aligning jig may include an alignment body portion facing each of both sides of the masking jig, an alignment rib extending downward from the alignment body portion, formed to be thinner than a thickness of the alignment body portion, and configured align the electrode lead by being inserted into the slot, and a slider extending upward from the alignment body portion and slidably coupled to the sliding groove portion.

The alignment rib may gather the electrode lead toward the bus bar while being inserted into the slot on an outer side of the electrode lead.

An alignment taper portion may be formed on an inner side of the alignment rib in a thickness direction to gather the electrode lead toward the bus bar.

A thickness of the slider may be formed smaller than the thickness of the alignment body portion.

A movement limiting portion configured to limit a movement distance of the aligning jig by being caught on a lower end portion of the sliding guide portion may be formed on an upper side of the alignment body portion.

The elastic member may be supported by an upper end portion of the alignment body portion and an upper end portion of the sliding groove portion.

The elastic member may be disposed on each of both sides of the alignment body portion in a longitudinal direction.

A stepped portion may be formed on a lower side of the alignment body portion to be spaced apart from a bent portion of the electrode lead, and a pressing surface portion of the masking jig may be disposed at a lower position than the stepped portion.

### Advantageous Effects

According to the present invention, since a pair of aligning jigs align positions of bent electrode leads, and a welding tool welds the electrode leads while a masking jig presses the bent electrode leads, the bent electrode leads can be welded to a correct position of a bus bar.

According to the present invention, since the electrode leads are welded to the correct position of the bus bar, an actual welding length of the electrode lead can be matched with a design welding length. In addition, a welding length of the electrode lead in each bus bar can be uniform.

According to the present invention, electrode leads are welded in a state in which the electrode leads are gathered on a bus bar, so that it is possible to prevent a bonding area and a bonding strength of a welding portion from being reduced.

According to the present invention, since an end portion of the bent electrode lead does not overlap a bent portion of the opposite electrode lead, which is bent to be rounded, it is possible to prevent an overlapping portion of the pair of electrode leads from being locally lifted or prevent a gap from widening. Accordingly, a bonding strength of the welding portion can be increased.

According to the present invention, an aligning jig is movably coupled to a masking jig and is elastically supported by an elastic member, so that an impact between the aligning jig and the electrode lead can be buffered. Accordingly, damage to the aligning jig and the electrode lead can be prevented.

In addition to the above-described effects, specific effects of the present invention will be described together with the following detailed description for implementing the present invention.

### DESCRIPTION OF DRAWINGS

FIG. 1 is a plan view schematically illustrating a secondary battery module according to an embodiment of the present disclosure.

FIG. 2 is a cross-sectional view schematically illustrating a state in which an electrode lead aligning and masking device is disposed on an upper side of a bus bar in the secondary battery module according to an embodiment of the present disclosure.

FIG. 3 is a perspective view schematically illustrating an electrode lead aligning and masking device according to a an embodiment of the present disclosure.

FIG. 4 is an exploded perspective view schematically illustrating the electrode lead aligning and masking device of FIG. 3.

FIG. 5 is a front view schematically illustrating the electrode lead aligning and masking device of FIG. 3.

FIG. 6 is a view schematically illustrating a state in which the electrode lead aligning and masking device of FIG. 3 is located on an upper side of an electrode lead.

FIG. 7 is a view schematically illustrating a state in which an alignment rig of the electrode lead aligning and masking device of FIG. 3 is inserted into a slot to align the electrode lead.

FIG. 8 is an exploded perspective view schematically illustrating an electrode lead aligning and masking device according to another embodiment of the present disclosure.

FIG. 9 is a perspective view schematically illustrating the electrode lead aligning and masking device of FIG. 8.

FIG. 10 is a front view schematically illustrating the electrode lead aligning and masking device of FIG. 8.

FIG. 11 is a cross-sectional view schematically illustrating the electrode lead aligning and masking device of FIG. 10 along line 11-11.

FIG. 12 is a cross-sectional view schematically illustrating the electrode lead aligning and masking device of FIG. 11 along line 12-12.

FIG. 13 is a cross-sectional view schematically illustrating the electrode lead aligning and masking device of FIG. 11 along line 13-13.

FIG. 14 is a cross-sectional view schematically illustrating a state in which the electrode lead of a battery cell is inserted into a slot of the bus bar in the secondary battery module according to an embodiment of the present disclosure.

FIG. 15 is a cross-sectional view schematically illustrating a state in which the electrode lead of the battery cell is bent on the bus bar in the secondary battery module according to an embodiment of the present disclosure.

FIG. 16 is a cross-sectional view schematically illustrating a state in which the aligning and masking device according to an embodiment of the present disclosure is located on an upper side of the bus bar.

FIG. 17 is a cross-sectional view schematically illustrating a state in which an aligning jig of the aligning and masking device according to an embodiment of the present disclosure is inserted into the slot between the bus bars.

FIG. 18 is a cross-sectional view schematically illustrating a state in which a stepped portion of the aligning jig the aligning and masking device according to an embodiment of the present disclosure presses a bent portion of the electrode lead.

FIG. 19 is a cross-sectional view schematically illustrating a state in which a pressing surface portion of a masking jig of the aligning and masking device according to an embodiment of the present disclosure presses the electrode lead.

FIG. 20 is a view schematically illustrating a state in which the electrode lead is welded to the bus bar via a welding space portion of the masking jig according to an embodiment of present disclosure.

1: secondary battery module
10: case
20: bus bar frame
21: bus bar
23: slot
30: battery cell
31: electrode tab
31a: first electrode tab
31b: second electrode tab
33: electrode lead
33a: first electrode lead
33b: second electrode lead
34: bent portion
100: electrode lead aligning and masking device
110: aligning jig
111: alignment body portion
112: movement limiting portion
113: alignment rib
114: alignment taper portion
115: stepped portion
116: slider
120: masking jig
121: welding space portion
122: masking body portion
123: pressing surface portion
125: sliding guide portion
126: sliding groove portion
130: elastic member

### MODES OF THE INVENTION

Hereinafter, exemplary embodiments of the present invention will be described with reference to the accompanying drawings in detail.

The present invention is not limited to the embodiments disclosed below, but will be variously changed and implemented in various different forms. The present embodiments are provided so that the present invention will be thorough and complete, and also to provide a more complete understanding of the scope of the present invention to those of ordinary skill in the art. Accordingly, it should be understood that the present invention is not limited to the embodiments disclosed below, but the configuration of any one embodiment and the configuration of another embodiment can be substituted or added, and the present invention includes all alterations, equivalents, and alternatives that are included in the technical spirit and scope of the present invention.

It should be understood that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present invention. In the drawings, sizes or thicknesses of components may be exaggerated, increased, or decreased for convenience of understanding, but the protection scope of the present invention should not be restrictively construed.

The terms used in the present specification are used only for the purpose of describing particular examples or embodiments and are not intended to limit the present invention. In addition, singular expressions include plural expressions unless clearly described as different meanings in the context. In the specification, the terms “comprises,” “comprising,” “includes,” “including,” “containing,” “has,” “having”, and other variations thereof are inclusive and therefore specify the presence of features, integers, steps, operations, components, parts, and/or combinations thereof disclosed in the specification. That is, in the specification, the terms “comprises,” “comprising,” “includes,” “including,” “containing,” “has,” “having”, and other variations thereof do not preclude the presence or addition of one or more other features, integers, steps, operations, components, parts, and/or combinations thereof.

The terms including ordinal numbers such as “first,” “second,” and the like may be used to describe various components, but the components are not limited by the terms. These terms are used only to distinguish one component from another component.

When one component is described as being “coupled” or “connected” to another component, it should be understood that one component can be coupled or connected directly to another component, and an intervening component can also be present between the components. In contrast, when one component is described as being “coupled directly to” or “connected directly to” another component, it should be understood that no intervening component is present between the components.

When one component is described as being “disposed above” or “disposed below” another component, it should be understood that one component can be disposed directly on another component, and an intervening component can also be present between the components.

Unless otherwise defined, all terms used herein, including technical or scientific terms, have the same meaning as commonly understood by those skilled in the art to which the present invention pertains. The terms such as those defined in a commonly used dictionary should be interpreted as having meanings consistent with meanings in the context of related technologies and should not be interpreted as ideal or excessively formal meanings unless explicitly defined in the present application.

Hereinafter, an electrode lead aligning and masking device according to an embodiment of the present invention will be described.

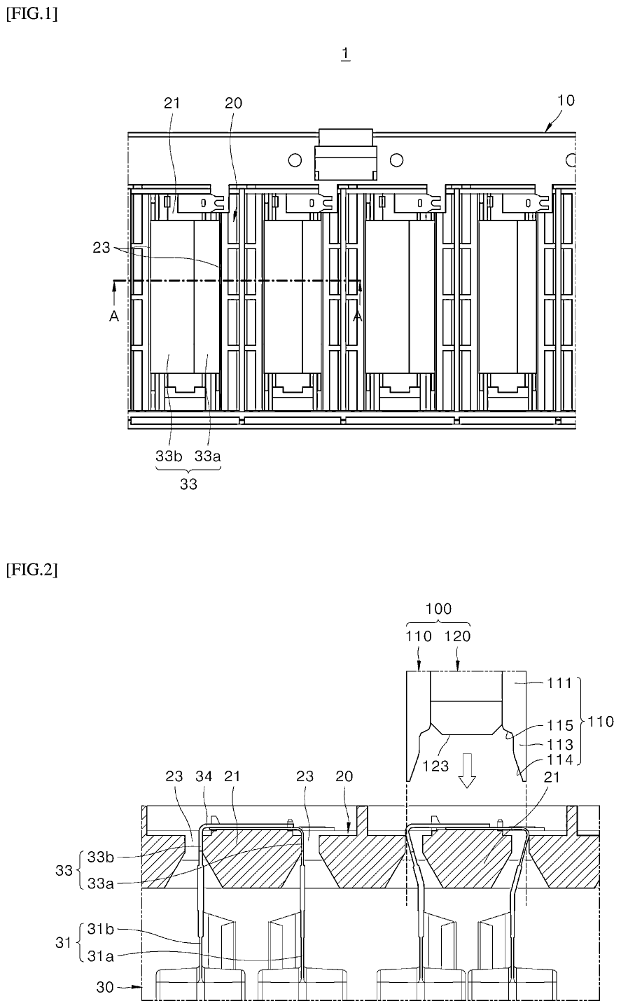

FIG. 1 is a plan view schematically illustrating a secondary battery module according to the present invention, and FIG. 2 is a cross-sectional view schematically illustrating a state in which an electrode lead aligning and masking device is disposed on an upper side of a bus bar in the secondary battery module according to the present invention.

Referring to FIGS. 1 and 2, in a secondary battery module 1, a plurality of battery cells 30 are stacked inside a case 10. An electrode tab 31 extends to protrude from each of the battery cells 30, and is welded to an electrode lead 33. A bus bar frame 20 is assembled to a battery cell stack (not shown). A plurality of bus bars 21 are arranged side by side in the bus bar frame 20. A slot 23 is formed between each of the plurality of bus bars 21 in the bus bar frame 20. The slot 23 may be formed with a width that is about 5 to 7 times a thickness of the electrode lead 33. When the bus bar frame 20 is assembled to the battery cell stack, a plurality of electrode leads 33 pass through the corresponding slots 23 and protrude vertically or nearly vertically outwardly from the bus bar frame 20.

In the battery cell stack, the electrode lead 33 is bent so as to come into close contact with the bus bar 21 using a bending tool (not shown) in a bending process. In each bus bar 21, a pair of electrode leads 33 are bent in a width direction of the bus bar 21 and overlap each other. When the operation of bending the electrode lead 33 on the bus bar 21 is completed, a welding process is performed. In the welding process, an electrode lead aligning and masking device 100 welds the bent electrode leads 33 to the bus bar 21 in a state in which the electrode leads 33 are aligned on the bus bar 21. This will be described in detail below.

The electrode lead aligning and masking device 100 according to the embodiment of the present invention is a device for aligning and masking the electrode leads 33 bent on the bus bar 21 of the secondary battery module 1 in the welding process of the electrode leads 33. Here, on the bus bar 21, the electrode leads 33 having the same polarity may be bent or the electrode leads 33 having opposite polarities may be bent. In addition, the electrode leads 33 having the same polarity may be bent on some bus bars 21, and the electrode leads 33 having opposite polarities may be bent on the remaining bus bars 21.

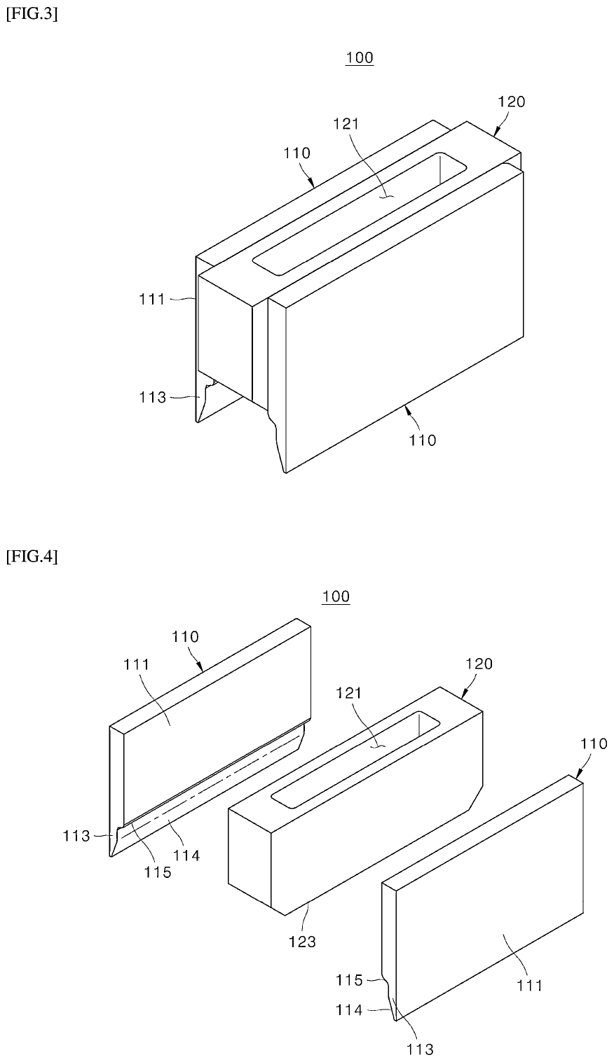

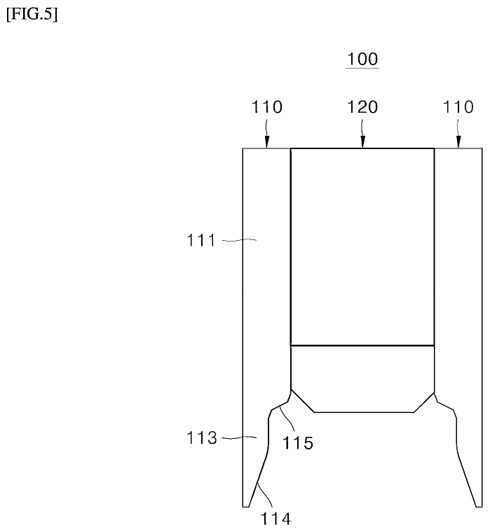

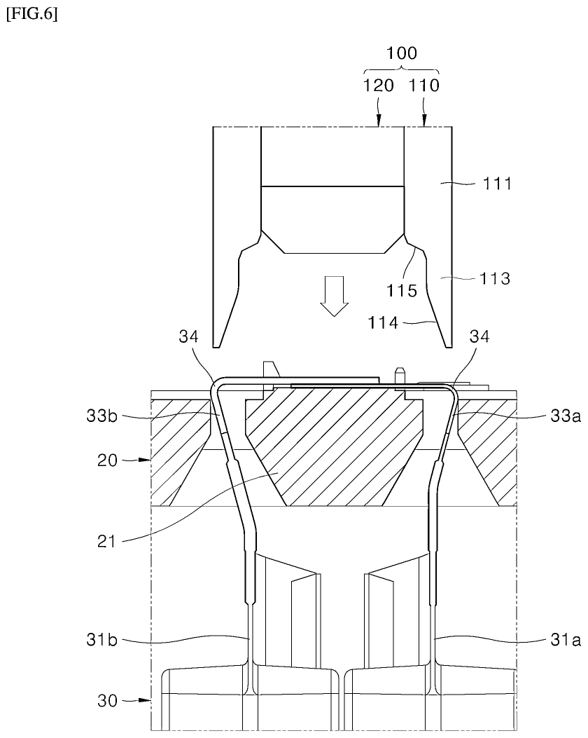

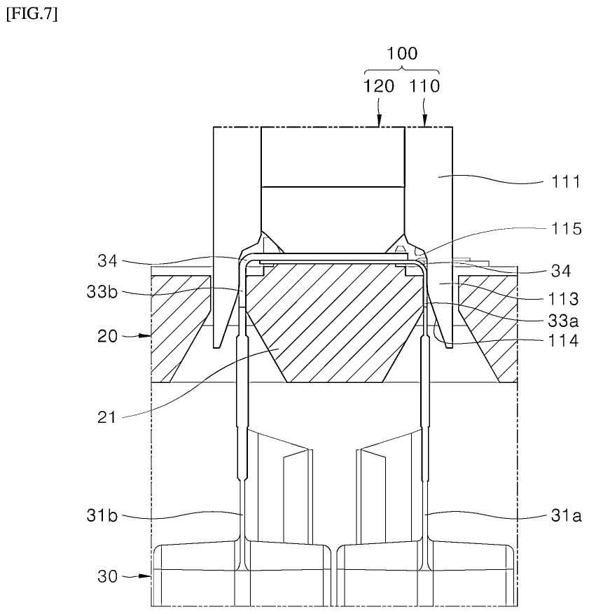

FIG. 3 is a perspective view schematically illustrating an electrode lead aligning and masking device according to a first embodiment of the present invention, FIG. 4 is an exploded perspective view schematically illustrating the electrode lead aligning and masking device according to the first embodiment of the present invention, FIG. 5 is a front view schematically illustrating the electrode lead aligning and masking device according to the first embodiment of the present invention, FIG. 6 is a view schematically illustrating a state in which the electrode lead aligning and masking device according to the first embodiment of the present invention is located on an upper side of an electrode lead, and FIG. 7 is a view schematically illustrating a state in which an alignment jig of the electrode lead aligning and masking device according to the first embodiment of the present invention is inserted into a slot to align the electrode lead.

The electrode lead aligning and masking device according to the first embodiment of the present invention will be described.

Referring to FIGS. 3 to 7, an electrode lead aligning and masking device 100 according to the first embodiment of the present invention includes a pair of aligning jigs 110 and a masking jig 120.

The pair of aligning jigs 110 are inserted into the slots 23 on both sides of the bus bar 21 and align positions of a pair of electrode leads 33. The pair of aligning jigs 110 gather the bent electrode leads 33 on both side surfaces of the bus bar 21 in the width direction while being inserted into the slots 23. Here, the pair of electrode leads 33 may be aligned to be in close contact with or slightly spaced apart from both side surfaces of the bus bar 21 in the width direction. In addition, when the pair of electrode leads 33 are bent on the bus bar 21, an end portion of one electrode lead 33 has a length so as to be spaced apart from a bent portion 34 of the other electrode lead 33 by a predetermined distance.

The masking jig 120 is coupled to the aligning jigs 110 and is formed to surround a welding portion of the electrode lead 33. The masking jig 120 shields a circumference of the welding portion so that sparks or spatters do not deviate from the welding portion when the electrode lead 33 is welded to the bus bar 21. Accordingly, it is possible to significantly reduce a welding defect rate by preventing spatters or sparks generated during welding from splashing to a surrounding structure.

As described above, since the pair of aligning jigs 110 align the positions of the bent electrode leads 33, and a welding tool (not shown) welds the electrode leads 33 in a state in which the masking jig 120 presses the bent electrode leads 33, the bent electrode leads 33 can be welded to a correct position of the bus bar 21. In addition, an actual welding length of the electrode lead 33 may be matched with a design welding length thereof. The welding length refers to a length at which the electrode lead is welded in parallel to a length of the bus bar 21 in the width direction. In addition, the electrode leads 33 may be prevented from spreading outward in the width direction of the bus bar 21. Accordingly, it is possible to prevent a bonding area and a bonding strength of the welding portion from being reduced and reduce a welding defect rate.

In addition, since the end portion of the bent electrode lead 33 does not overlap the bent portion 34 of the opposite electrode lead 33, which is bent to be rounded, it is possible to prevent an overlapping portion of the pair of electrode leads 33 from being locally lifted or prevent a gap from widening. Accordingly, the bonding strength of the welding portion can be increased.

In addition, since the welding length of the pair of electrode leads 33 in each bus bar 21 becomes uniform, the actual welding length is matched with a required design dimension, thereby reducing the welding defect rate.

The pair of aligning jigs 110 are coupled to both sides of the masking jig 120 in the width direction. At this time, the pair of aligning jigs 110 may be welded or adhered to both sides of the masking jig 120 in the width direction or coupled to the both sides by fastening members such as screws or rivets. Accordingly, the aligning jigs 110 and the masking jig 120 may be lifted and moved by one moving device (not shown) to align and weld the electrode leads 33.

The aligning jig 110 gathers the electrode lead 33 toward the bus bar 21 while being inserted into the slot 23 on an outer side of the electrode lead 33. Here, outer sides of the pair of aligning jigs 110 in a thickness direction may be in contact with or be spaced apart from outer surfaces of the slot 23. In addition, inner sides of the pair of aligning jigs 110 in the thickness direction may be in contact with outer side surfaces of the electrode leads 33. Accordingly, when the aligning jig 110 descends, the pair of electrode leads 33 may be aligned while being gathered toward the bus bar 21.

The aligning jig 110 includes an alignment body portion 111 and an alignment rib 113.

The alignment bodies 111 face both sides of the masking jig 120. The alignment bodies 111 may be fixed to both sides of the masking jig 120 in the width direction by welding or an adhesive, or may be fixed to both sides of the masking jig 120 in the width direction by fastening members such as screws or rivets.

The alignment rib 113 extends downward from the alignment body portion 111 and is formed to be thinner than a thickness of the alignment body portion 111. The alignment rib 113 aligns the electrode lead 33 while being inserted into the slot 23. The alignment rib 113 presses the outer side surfaces of the electrode lead 33 toward the bus bar 21 to bring the electrode lead 33 into close contact with the bus bar 21 or align the electrode lead 33 to be finely separated from the bus bar 21. Whether the electrode lead 33 is in contact with the bus bar 21 may be determined according to a thickness of the aligning jig.

An alignment taper portion 114 is formed on an inner side of the alignment rib 113 in the thickness direction to gather the electrode lead 33 toward the bus bar 21. In this case, a thickness of the alignment rib 113 becomes gradually smaller toward the lower side due to the alignment taper portion 114. Accordingly, a lower end portion of the alignment rib 113 is easily inserted between the outer side surface of the electrode lead 33 and an outer side surface of the slot 23, and as the alignment rib 113 descends, the electrode lead 33 may be aligned while being pressed toward the bus bar 21. In addition, it is possible to prevent the alignment rib 113 or the electrode lead 33 from being damaged or broken due to the end portion of the alignment rib 113 caught on the bent portion 34 of the electrode lead 33 when the alignment rib 113 is inserted into the slot 23.

A stepped portion 115 may be formed on a lower side of the alignment body portion 111 to be spaced apart from the bent portion 34 of the electrode lead 33. Here, a pressing surface portion 123 of the masking jig 120 is disposed at a lower position than the stepped portion 115. The stepped portion 115 may be formed to be horizontal or slightly inclined with respect to the pressing surface portion 123. Accordingly, when the pressing surface portion 123 of the masking jig 120 presses the electrode lead 33, the bent portion 34 of the electrode lead 33 is spaced apart from the stepped portion 115 by a predetermined distance, thereby preventing the alignment body portion 111 from pressing the bent portion 34 of the electrode lead 33. Furthermore, the electrode lead 33 or the electrode tab 31 may be prevented from being bent or broken by a pressing force of the alignment body portion 111.

The aligning jig 110 is formed in the shape of a rectangular panel. A length of the aligning jig 110 may be formed to be slightly smaller than a length of the slot 23. In addition, the length of the aligning jig 110 may also be formed to be equal to or slightly larger than a length of the electrode lead 33. Of course, the aligning jig 110 may be formed in various shapes such as the shape of a sawtooth, the shape of a plurality of bars arranged in a row, and the like, as long as it is inserted into the slot 23 and aligns the electrode lead 33.

A welding space portion 121 passing through the masking jig 120 in a vertical direction is formed in the masking jig 120. The welding tool may pass through the welding space portion 121 and weld the bent electrode lead 33 to the bus bar 21. The welding tool may be a laser welding tool that welds the electrode leads 33 by irradiating a laser thereto, or a spot welding tool that welds the electrode leads 33 by applying an electric current thereto. Various welding types may be applied according to the type of material of each of the electrode lead 33 and the bus bar 21. As described above, since the welding tool enters the welding space portion 121 to weld the electrode lead 33, it is possible to prevent spatters or welding sparks from splashing around the electrode lead 33.

The masking jig 120 may be formed in the shape of a rectangular cylinder parallel to the bus bar 21 in the longitudinal direction. The welding space portion 121 is formed parallel to the bus bar 21 in the longitudinal direction. A width of the masking jig 120 may be formed smaller than a width of the bus bar 21. A width of the welding space portion 121 may be formed smaller than the width of the bus bar 21. A length of the welding space portion 121 may be formed to be slightly smaller than the length of the electrode lead 33. A cross section of the welding space portion 121 may be formed in a rectangular shape parallel to the bus bar 21 in the longitudinal direction. Since the masking jig 120 is formed in the shape of a rectangular cylinder, the overlapping portion of the electrode leads 33 may be welded in the longitudinal direction.

The masking jig 120 presses the bent electrode leads 33 to the bus bar 21. Accordingly, when the welding tool welds the electrode leads 33, the overlapping portion of the electrode leads 33 may be prevented from being lifted or spaced. Furthermore, it is possible to prevent the welding bonding strength of the overlapping portion of the electrode leads 33 from being degraded. In addition, a local temperature deviation of the electrode lead 33 due to the lifting or spacing of the electrode lead 33 is prevented from occurring, thereby preventing a welding defect.

The electrode lead aligning and masking device 100 according to the first embodiment of the present invention may include a pair of aligning jigs 110 and one masking jig 120 to align a pair of electrode leads 33 to one bus bar 21. The electrode lead aligning and masking device 100 aligns and masks the electrode leads 33 on one bus bar 21 each time the electrode lead aligning and masking device 100 descends.

In addition, the electrode lead aligning and masking device 100 according to the first embodiment of the present invention may be manufactured in a form in which four or more aligning jigs 110 and two or more masking jigs 120 are arranged to align a pair of electrode leads 33 to each of at least two or more bus bars 21. The electrode lead aligning and masking device 100 may simultaneously align the electrode leads 33 to two or more bus bars 21 each time the electrode lead aligning and masking device 100 descends.

Next, an electrode lead aligning and masking device according to a second embodiment of the present invention will be described.

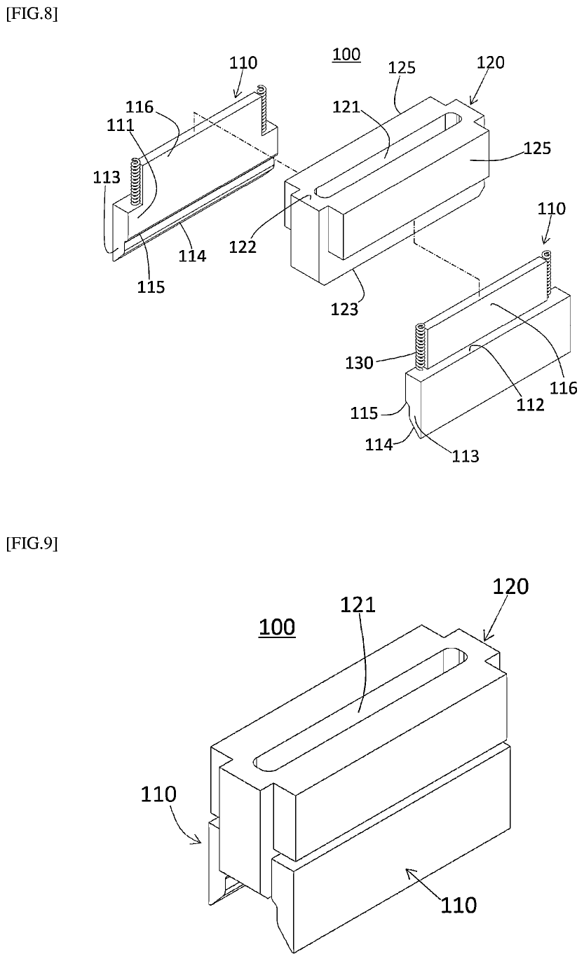

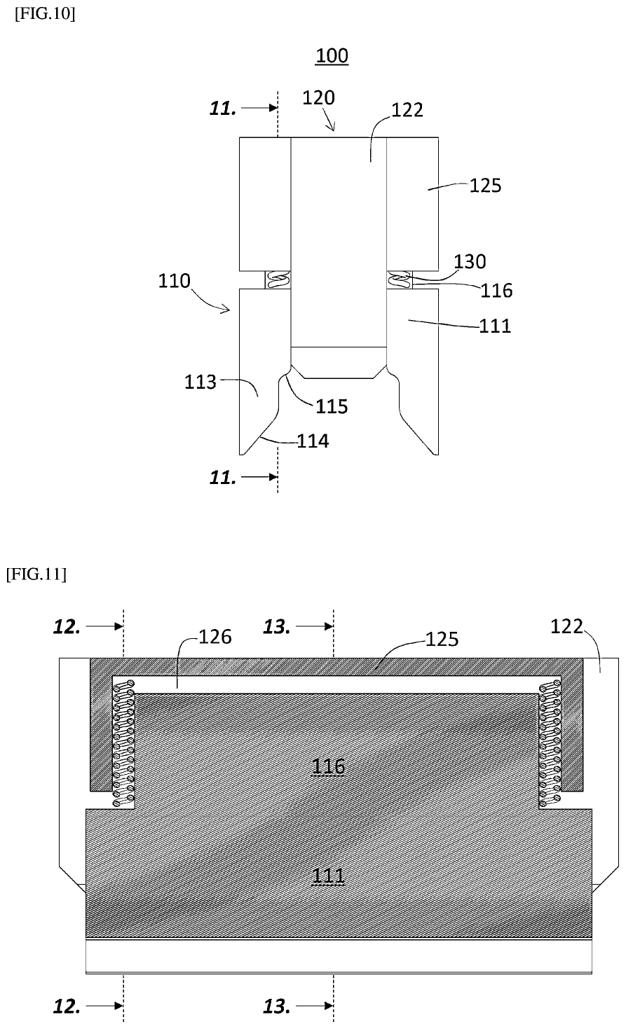

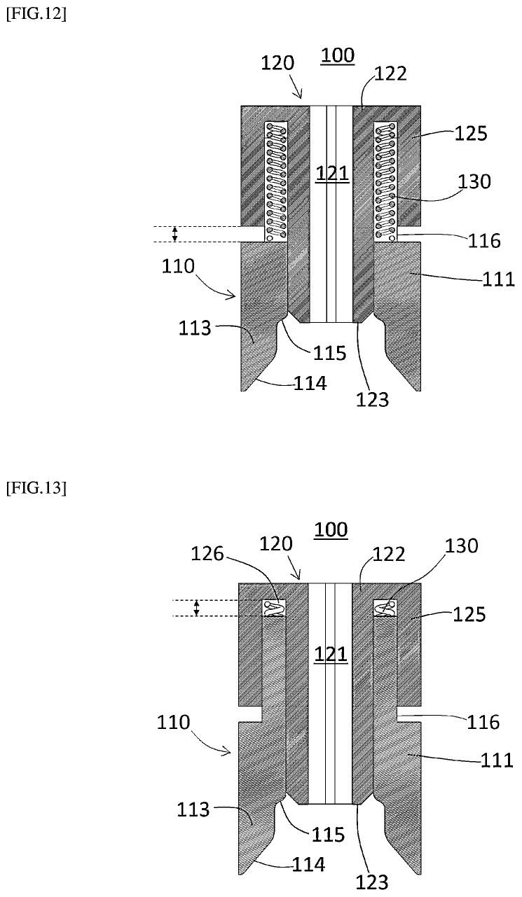

FIG. 8 is an exploded perspective view schematically illustrating an electrode lead aligning and masking device according to a second embodiment of the present invention, FIG. 9 is a perspective view schematically illustrating the electrode lead aligning and masking device according to the second embodiment of the present invention, FIG. 10 is a front view schematically illustrating the electrode lead aligning and masking device according to the second embodiment of the present invention, FIG. 11 is a cross-sectional view schematically illustrating a state in which the electrode lead aligning and masking device of FIG. 10 is cut along line 11-11, FIG. 12 is a cross-sectional view schematically illustrating a state in which the electrode lead aligning and masking device of FIG. 11 is cut along line 12-12 in the electrode lead, and FIG. 13 is a cross-sectional view schematically illustrating a state in which the electrode lead aligning and masking device of FIG. 11 is cut along line 13-13 in the electrode lead.

Referring to FIGS. 8 to 13, an electrode lead aligning and masking device 100 according to the second embodiment of the present invention includes a pair of aligning jigs 110, a masking jig 120, and at least two elastic members 130.

The pair of aligning jigs 110 are inserted into the slots 23 on both sides of the bus bar 21 and align positions of a pair of electrode leads 33. The pair of aligning jigs 110 gather the bent electrode leads 33 on both side surfaces of the bus bar 21 in the width direction while being inserted into the slots 23. Here, the pair of electrode leads 33 may be aligned to be in close contact with or slightly spaced apart from both side surfaces of the bus bar 21 in the width direction. In addition, when the pair of electrode leads 33 are bent on the bus bar 21, an end portion of one electrode lead 33 may have a length so as to be spaced apart from a bent portion 34 of the other electrode lead 33 by a predetermined distance.

The masking jig 120 is disposed between the pair of aligning jigs 110 and is formed to surround a welding portion of the electrode lead 33. The aligning jigs 110 are movably coupled to the masking jig 120. The masking jig 120 shields a circumference of the welding portion so that sparks or spatters do not deviate from the welding portion when the electrode lead 33 is welded to the bus bar 21. Accordingly, it is possible to significantly reduce a welding defect rate by preventing spatters or sparks generated during welding from splashing to a surrounding structure.

At least two elastic members 130 are installed on both sides of the masking jig 120 to elastically support the pair of aligning jigs 110. The elastic member 130 may be a coil spring configured to connect the masking jig 120 and the aligning jig 110. The elastic member 130 may applied in various forms and in various positions, as long as it elastically support the aligning jig 110.

As described above, the aligning jig 110 is movably coupled to the masking jig 120 and is elastically supported by the elastic member 130. Accordingly, since the electrode leads 33 are aligned while the aligning jigs 110 move up and down, deformation of the electrode leads 33 may be minimized. In addition, since the impact of the aligning jig 110 and the electrode lead 33 is buffered at the moment when the aligning jig 110 presses the electrode lead 33, it is possible to prevent damage to the aligning jig 110 and the electrode lead 33. In addition, it is possible to prevent scratches from occurring on a surface of the electrode lead 33 and to significantly reduce the possibility of overheating and ignition of the electrode lead 33.

In addition, since the pair of aligning jigs 110 align the positions of the bent electrode leads 33, and a welding tool (not shown) welds the electrode leads 33 in a state in which the masking jig 120 presses the bent electrode leads 33, the bent electrode leads 33 can be welded to a correct position of the bus bar 21. In addition, an actual welding length of the electrode lead 33 can be matched with a design welding length thereof. The welding length refers to a length at which the electrode lead is welded in parallel to a length of the bus bar 21 in the width direction. In addition, the electrode leads 33 may be prevented from spreading outward in the width direction of the bus bar 21. Accordingly, it is possible to prevent a bonding area and a bonding strength of the welding portion from being reduced and reduce a welding defect rate.

In addition, since the end portion of the bent electrode lead 33 does not overlap the bent portion 34 of the opposite electrode lead 33, which is bent to be rounded, it is possible to prevent an overlapping portion of the pair of electrode leads 33 from being locally lifted or prevent a gap from widening. Accordingly, a bonding strength of the welding portion can be increased.

In addition, since the welding length of the pair of electrode leads 33 in each bus bar 21 becomes uniform, the actual welding length is matched with a required design dimension, thereby reducing the welding defect rate.

The masking jig 120 includes a masking body portion 122 and a sliding guide portion 125.

A welding space portion 121 passing through the masking body portion 122 in the vertical direction is formed in the masking body portion 122. The welding space portion 121 may be formed in the shape of a long hole parallel to the masking body portion 122 in the longitudinal direction. Accordingly, the welding tool may approach and weld the electrode lead 33 via the welding space portion 121.

The welding tool may be a laser welding tool that welds the electrode leads 33 by irradiating a laser thereto, or a spot welding tool that welds the electrode leads 33 by applying an electric current thereto. Various welding types may be applied according to the type of material of each of the electrode lead 33 and the bus bar 21. As described above, since the welding tool enters the welding space portion 121 to weld the electrode lead 33, it is possible to prevent spatters or welding sparks from splashing around the electrode lead 33.

The sliding guide portions 125 are disposed on both sides of the masking body portion 122. A sliding groove portion 126 is formed in the sliding guide portion 125 such that the aligning jig 110 is slidably coupled to the sliding guide portion 125. The sliding groove portion 126 is a space surrounded by a side surface of the masking body portion 122 and an inner side surface of the sliding guide portion 125. The sliding groove portion 126 is formed in the shape of a long hole along a longitudinal direction of the masking body portion 122. In addition, a lower side of the sliding groove portion 126 is open. The sliding guide portion 125 supports the aligning jig 110 so that the aligning jig 110 does not move.

The aligning jig 110 gathers the electrode lead 33 toward the bus bar 21 while being inserted into the slot 23 on an outer side of the electrode lead 33. Here, outer sides of the pair of aligning jigs 110 in a thickness direction may be in contact with or be spaced apart from outer side surfaces of the slots 23. In addition, inner sides of the pair of aligning jigs 110 in the thickness direction may be in contact with outer side surfaces of the electrode leads 33. Accordingly, when the aligning jig 110 descends, the pair of electrode leads 33 may be aligned while being gathered toward the bus bar 21.

The aligning jig 110 includes an alignment body portion 111, an alignment rib 113, and a slider 116. The aligning jig 110 may be entirely formed in the shape of a rectangular panel.

The alignment bodies 111 face both sides of the masking jig 120. An inner side surface of the alignment body portion 111 is formed in a flat plate shape so as to be in surface contact with a side surface of the masking jig 120 when the aligning jig 110 moves in the vertical direction.

The alignment rib 113 extends downward from the alignment body portion 111 and is formed to be thinner than a thickness of the alignment body portion 111. The alignment rib 113 align the electrode lead 33 by being inserted into the slot 23 between the bus bars 21. The alignment rib 113 may be formed to have the same length as or a slightly different length from the alignment body portion 111.

The slider 116 extends upward from the alignment body portion 111 and is slidably coupled to the sliding groove portion 126. The slider 116 may be formed in a plate shape so as to be inserted into the sliding groove portion 126. A length of the slider 116 may be formed to be slightly smaller than a length of the sliding groove portion 126.

A thickness of the slider 116 may be formed smaller than a thickness of the alignment body portion 111. Accordingly, a lower end portion of the slider 116 and an upper end portion of the alignment body portion 111 may be formed to be stepped. In addition, since the thickness of the slider 116 is formed to be small, a width of the sliding guide portion 125 and a width of the sliding groove portion 126 may be prevented from increasing unnecessarily.

An alignment taper portion 114 is formed on an inner side of the alignment rib 113 in the thickness direction to gather the electrode lead 33 toward the bus bar 21. In this case, a thickness of the alignment rib 113 becomes gradually smaller toward the lower side due to the alignment taper portion 114. Accordingly, a lower end portion of the alignment rib 113 is easily inserted between the outer side surface of the electrode lead 33 and an outer side surface of the slot 23, and as the alignment rib 113 descends, the electrode lead 33 may be aligned while being pressed toward the bus bar 21. In addition, it is possible to prevent the alignment rib 113 or the electrode lead 33 from being damaged or broken due to the end portion of the alignment rib 113 caught on the bent portion 34 of the electrode lead 33 when the alignment rib 113 is inserted into the slot 23.

A movement limiting portion 112 configured to limit a movement distance of the aligning jig 110 by being caught on a lower end portion of the sliding guide portion 125 is formed on an upper side of the alignment body portion 111. The movement limiting portion 112 may be a step formed at a boundary between the upper end portion of the alignment body portion 111 and the lower end portion of the slider 116. The movement limiting portion 112 may be formed in various structures on the alignment body portion 111 or the slider 116.

A stepped portion 115 may be formed on a lower side of the alignment body portion 111 to be spaced apart from the bent portion 34 of the electrode lead 33. Here, a pressing surface portion 123 of the masking jig 120 is disposed at a lower position than the stepped portion 115. The stepped portion 115 may be formed to be horizontal or slightly inclined with respect to the pressing surface portion 123. Accordingly, when the pressing surface portion 123 of the masking jig 120 presses the electrode lead 33, the bent portion 34 of the electrode lead 33 is spaced apart from the stepped portion 115 by a predetermined distance, thereby preventing the alignment body portion 111 from pressing the bent portion 34 of the electrode lead 33. Furthermore, the electrode lead 33 or the electrode tab 31 may be prevented from being bent or broken by a pressing force of the alignment body portion 111.

A length of the aligning jig 110 may be formed to be slightly smaller than a length of the slot 23. In addition, the length of the aligning jig 110 may also be formed to be equal to or slightly larger than a length of the electrode lead 33. Of course, the aligning jig 110 may be formed in various shapes such as the shape of a sawtooth, the shape of a plurality of bars arranged in a row, and the like, as long as it is inserted into the slot 23 and aligns the electrode lead 33.

The masking jig 120 may be formed in the shape of a rectangular cylinder parallel to the bus bar 21 in the longitudinal direction. A width of the masking jig 120 may be formed smaller than a width of the bus bar 21. A width of the welding space portion 121 may be formed smaller than the width of the bus bar 21. A length of the welding space portion 121 may be formed to be slightly smaller than the length of the electrode lead 33. A cross section of the welding space portion 121 may be formed in a rectangular shape parallel to the bus bar 21 in the longitudinal direction. Since the masking jig 120 is formed in the shape of a rectangular cylinder, the overlapping portion of the electrode leads 33 may be welded in the longitudinal direction.

The masking jig 120 presses the bent electrode leads 33 on the bus bar 21. Accordingly, when the welding tool welds the electrode leads 33, the overlapping portion of the electrode leads 33 may be prevented from being lifted or spaced. Furthermore, it is possible to prevent the welding bonding strength of the overlapping portion of the electrode leads 33 from being degraded. In addition, a local temperature deviation of the electrode lead 33 due to the lifting or spacing of the electrode lead 33 is prevented from occurring, thereby preventing a welding defect.

The elastic member 130 may be supported by the upper end portion of the alignment body portion 111 and an upper end portion of the sliding groove portion 126. The elastic members 130 may be disposed on both sides of the alignment body portion 111, respectively, in the longitudinal direction. Since the elastic members 130 are disposed on both sides of the alignment body portion 111 in the longitudinal direction, the aligning jig 110 may be finely inclined to one side in the longitudinal direction. Accordingly, even when the electrode lead 33 or the bus bar 21 is slightly inclined, the electrode lead 33 may be aligned as the aligning jig 110 is finely inclined to one side in the longitudinal direction.

The electrode lead aligning and masking device 100 according to the second embodiment of the present invention may include a pair of aligning jigs 110 and one masking jig 120 to align a pair of electrode leads 33 to one bus bar 21. The electrode lead aligning and masking device 100 aligns and masks the electrode leads 33 on one bus bar 21 each time the electrode lead aligning and masking device 100 descends.

In addition, the electrode lead aligning and masking device 100 according to the second embodiment of the present invention may be manufactured in a form in which four or more aligning jigs 110 and two or more masking jigs 120 are arranged to align a pair of electrode leads 33 to each of at least two or more bus bars 21. The electrode lead aligning and masking device 100 may simultaneously align the electrode leads 33 to two or more bus bars 21 each time the electrode lead aligning and masking device 100 descends.

An operation of the aligning and masking device according to the second embodiment of the present invention configured as described above will be described.

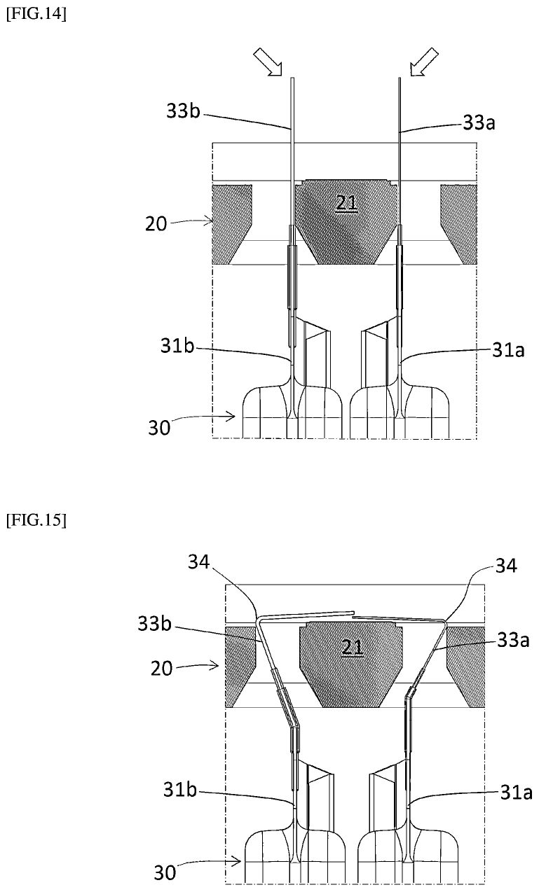

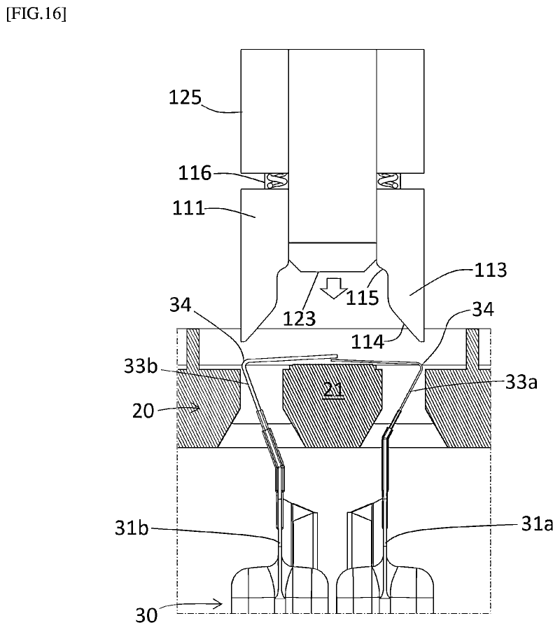

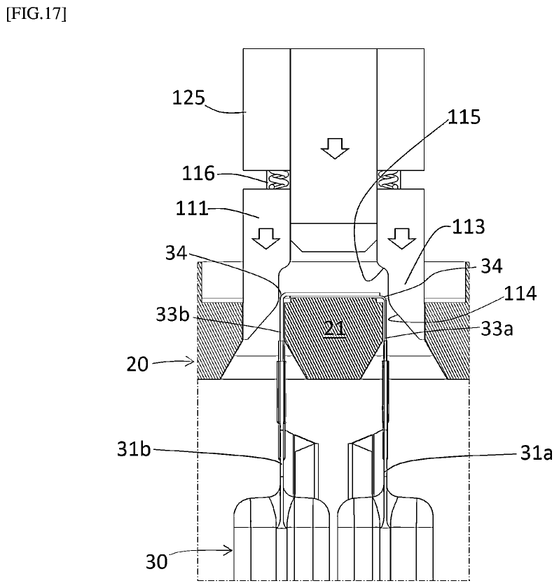

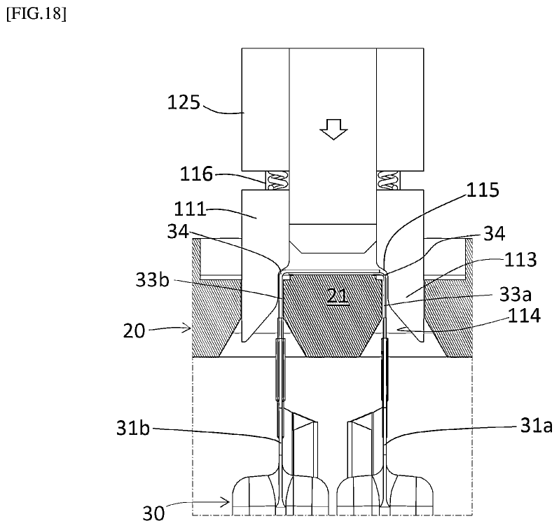

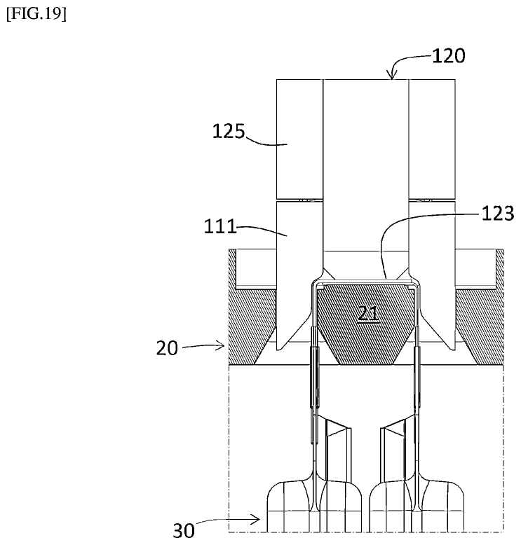

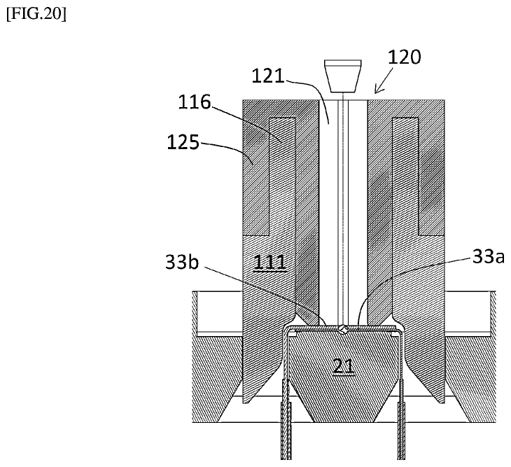

FIG. 14 is a cross-sectional view schematically illustrating a state in which the electrode lead of the battery cell is inserted into the slot of the bus bar in the secondary battery module according to the present invention, FIG. 15 is a cross-sectional view schematically illustrating a state in which the electrode lead of the battery cell is bent on the bus bar in the secondary battery module according to the present invention, FIG. 16 is a cross-sectional view schematically illustrating a state in which the aligning and masking device according to the present invention is located on an upper side of the bus bar, FIG. 17 is a cross-sectional view schematically illustrating a state in which the aligning jig of the aligning and masking device according to the present invention is inserted into the slot between the bus bars, FIG. 18 is a cross-sectional view schematically illustrating a state in which the stepped portion of the aligning jig the aligning and masking device according to the present invention presses the bent portion of the electrode lead, FIG. 19 is a cross-sectional view schematically illustrating a state in which the pressing surface portion of the masking jig of the aligning and masking device according to the present invention presses the electrode lead, and FIG. 20 is a view schematically illustrating a state in which the electrode lead is welded to the bus bar via the welding space portion of the masking jig according to the present invention.

Referring to FIGS. 14 to 20, the electrode leads 33 of the battery cell 30 are inserted into the slots 23 on both sides of the bus bar 21. Here, the electrode leads 33 may be vertically inserted on both sides of the bus bar 21.

A bending device (not shown) presses and bends the electrode lead 33 toward the bus bar 21. At this time, the pair of electrode leads 33 may be spread toward both sides of the bus bar 21 or may be spaced apart from each other on both side surfaces of the bus bar 21 (see FIG. 15).

The aligning and masking device 100 is moved to an upper side of the bus bar 21. At this time, the aligning jig 110 maintains the state of being most descended from the sliding guide portion 25 by an elastic force of the elastic member 130.

When the aligning and masking device 100 descends, the aligning jigs 110 are inserted into the slots 23 on both sides of the bus bar 21. At this time, when an impact is applied to the bent portion 34 of the electrode lead 33 by the alignment taper portion 114 of the aligning jig 110, the impact applied to the electrode lead 33 is buffered as the elastic member 130 is slightly contracted.

The alignment taper portion 114 of the aligning jig 110 gently descends while sliding along the bent portion 34 of the electrode lead 33. The electrode lead 33 is gathered toward the bus bar 21 as the alignment taper portion 114 presses an outer side of the electrode lead 33.

As the aligning jig 110 further descends, the electrode leads 33 are in close contact with both side surfaces of the bus bar 21 (see FIG. 17). Here, the electrode lead 33 may be lifted or spaced apart from an upper surface of the bus bar 21.

When the aligning jig 110 is completely inserted into the slot 23, the stepped portion 115 of the aligning jig 110 is in close contact with the bent portion 34 of the electrode lead 33 (FIG. 18). At this time, a pressing force of the aligning and masking device 100 is applied to the bent portion 34 of the electrode lead 33.

The masking jig 120 descends in a state in which the stepped portion 115 of the aligning jig 110 is caught on the bent portion 34 of the electrode lead 33. When the masking jig 120 descends in a state in which the aligning jig 110 is stopped, the elastic member 130 is contracted in the longitudinal direction. When the pressing surface portion 123 on a lower side of the masking jig 120 presses the electrode lead 33, the electrode lead 33 is brought into close contact with the upper surface of the bus bar 21. Subsequently, the welding tool welds the electrode lead 33 to the upper surface of the bus bar 21 via the welding space portion 121 of the masking jig 120 see (FIG. 20). Accordingly, the electrode lead 33 may be welded to the bus bar 21 in a state in which the electrode lead 33 is brought into close contact with both side surfaces and the upper surface of the bus bar 21.

While the present invention has been described above with reference to the accompanying drawings, the present invention is not limited to the drawings and the embodiments disclosed in the present specification, and it is apparent that the present invention may be variously changed by those skilled in the art without departing from the technical spirit of the present invention. Further, even though the operational effects of the configurations of the present invention have not been explicitly disclosed and described in the description of the embodiment of the present invention, the effects, which can be expected by the corresponding configurations, should, of course, be acceptable.

1. An electrode lead aligning and masking device for aligning electrode leads positioned on bus bars in a welding process, the electrode lead aligning and masking device comprising:
a pair of aligning jigs, each jig configured to be inserted into a slot between the bus bars to align the electrode leads with the bus bars; and
a masking jig disposed between the pair of aligning jigs to surround welding portions of the electrode leads.

2. The electrode lead aligning and masking device of claim 1, wherein the pair of aligning jigs are coupled to both sides of the masking jig along a width direction of the masking jig.

3. The electrode lead aligning and masking device of claim 1, wherein the aligning jig is configured to direct the electrode leads towards the bus bar upon insertion of the electrode leads into the slot.

4. The electrode lead aligning and masking device of claim 3, wherein each aligning jig includes
an alignment body portion adjacent to each side of the masking jig and
an alignment rib extending from the alignment body portion, the alignment being thinner than a thickness of the alignment body portion, and configured to align the electrode lead during insertion into the slot.

5. The electrode lead aligning and masking device of claim 4, further including an alignment taper portion on an inner side of the alignment rib in a thickness direction to guide the electrode lead towards the bus bar.

6. The electrode lead aligning and masking device of claim 5, wherein
the alignment body portion includes a stepped portion on a lower side thereof, the stepped portion being spaced apart from a bent portion of the electrode lead,
a pressing surface portion of the masking jig being positioned below the stepped portion.

7. The electrode lead aligning and masking device of claim 1, wherein the aligning jig is a rectangular panel.

8. The electrode lead aligning and masking device of claim 1, wherein the masking jig includes a welding space portion extending in a vertical direction therethrough.

9. The electrode lead aligning and masking device of claim 8, wherein
the masking jig defines a rectangular cylinder parallel to the bus bar in a longitudinal direction,
the welding space portion being parallel to the bus bar in the longitudinal direction.

10. The electrode lead aligning and masking device of claim 1, wherein the masking jig configured to press the electrode lead toward the bus bar.

11. An electrode lead aligning and masking device for aligning electrode leads positioned on bus bars in a welding process, the electrode lead aligning and masking device comprising:
a pair of aligning jigs, each jig configured to be inserted into a slot between the bus bars to align the electrode leads with the bus bars;
a masking jig disposed between the pair of aligning jigs to surround welding portions of the electrode leads, the aligning jigs being movably coupled to the masking jig; and
at least two elastic members, each elastic member positioned on opposing sides of the masking jig configured to provide elastic support to the pair of aligning jigs.

12. The electrode lead aligning and masking device of claim 11, wherein the masking jig includes:
a masking body portion having a welding space portion passing therethrough in a vertical direction and
a sliding guide portion disposed on each side of the masking body portion, the sliding guide portion including a sliding groove portion, the aligning jig being slidably coupled to the sliding groove portion.

13. The electrode lead aligning and masking device of claim 12, wherein the aligning jig includes
an alignment body portion, and alignment rib and a slider, the alignment body portion being configured to face each side of the masking jig,
the alignment rib extending downward from the alignment body portion, the alignment rib having a thickness less than a thickness of the alignment body portion, the alignment rib being configured to align the electrode lead when inserted into the slot,
the slider extending upward from the alignment body portion and configured to be slidably coupled to the sliding groove portion.

14. The electrode lead aligning and masking device of claim 13, wherein the alignment rib is configured to guide the electrode lead toward the bus bar while being inserted into the slot.

15. The electrode lead aligning and masking device of claim 13, wherein an alignment taper portion on an inner side of the alignment rib in a thickness direction is configured to guide the electrode lead toward the bus bar.

16. The electrode lead aligning and masking device of claim 15, wherein a thickness of the slider is less than a thickness of the alignment body portion.

17. The electrode lead aligning and masking device of claim 13, further including a movement limiting portion on an upper side of the alignment body, the movement limiting portion being configured to limit movement of the aligning jig by engaging a lower end portion of the sliding guide portion.

18. The electrode lead aligning and masking device of claim 13, wherein the elastic member is supported by an upper end portion of the alignment body portion and an upper end portion of the sliding groove portion.

19. The electrode lead aligning and masking device of claim 18, wherein the elastic member is disposed on both sides of the alignment body portion in a longitudinal direction.

20. The electrode lead aligning and masking device of claim 13, wherein the alignment body includes a stepped portion on a lower side thereof, the stepped portion being spaced apart from a bent portion of the electrode lead,
a pressing surface portion of the masking jig being positioned below the stepped portion.
